(19) United States
(12) Patent Application Publication
(10) Pub. No.: US 2006/0184379 A1
(43) Pub. Date: Aug. 17, 2006

(54) Embedded warranty management

(75) Inventors: George B. Tan, Chicago, IL (US); Michael J. Biltz, San Francisco, CA (US); Vishal Gurbuxani, Santa Clara, CA (US)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: Accenture Global Services GmBH

(21) Appl. No.: 11/276,073

(22) Filed: Feb. 13, 2006

Related U.S. Application Data
(63) Continuation-in-part of application No. 11/069,211, filed on Feb. 28, 2005.
(60) Provisional application No. 60/652,698, filed on Feb. 14, 2005.

(51) Int. Cl. G06Q 99/00

(52) U.S. Cl. 705/1

(57) ABSTRACT

Methods and systems for obtaining and analyzing data from embedded sensors in electronic products for warranty management. A data collection unit in an electronic product collects and reports data about environmental factors that is relevant about a warranty agreement and transmits the data over a communications link to a data interpretation unit. The data interpretation unit may obtain warranty information from an electronic product and query a database to determine if the electronic product has been exposed to environmental factors outside the ranges that are specified in the warranty agreement. The data interpretation unit may query a database to determine the product grade of the electronic product based on the sensor data and to determine an estimated product value. The data interpretation unit may query a database to determine an estimated warranty cost of an extended warranty based on the condition of the electronic product and historical warranty value.

### EMBEDDED WARRANTY MANAGEMENT

This application is a continuation-in-part of common-owned, co-pending U.S. application Ser. No. 11/069,211 filed on Feb. 28, 2005, naming George B. Tan and Michael J. Biltz as inventors and claiming priority to provisional U.S. Application No. 60/652,698 (Attorney Docket No. 005222.00389, “Embedded Warranty Management”), filed Feb. 14, 2005.

### FIELD OF THE INVENTION

This invention relates generally to warranty management for electronic products. More particularly, the invention provides methods and systems for obtaining and analyzing data from sensors integrated with electronic products.

### BACKGROUND OF THE INVENTION

Retailers and manufacturers spend billions of dollars a year on warranty claims. American manufacturers alone currently spend $25 billion a year on their warranty operations. The cost of warranty claims amounts to roughly 2.5% to 4.5% of a manufacturer's revenue in a given year. Unfortunately, not all of these claims are legitimate. An estimated 10% to 15% of warranty claims are fraudulent or invalid. For one major electronics manufacturer, an estimated $100 million annually is lost on fraudulent warranty claims. In other words, manufacturers are replacing and repairing products that they shouldn't be, resulting in substantial losses.

While warranties are a drain on manufacturers, they are a boon to many companies such as retailers. Analysts estimate that, in 2003, extended warranty contracts accounted for nearly all of one major retailer's operating revenue. An estimated 45% of operating revenue comes from these same contracts for another major retailer. Many other businesses are focused solely on extended warranties. Increasing the potential revenue from warranty sales may significantly increase profits for businesses that rely on warranty sales.

Many warranties currently do not adequately define product mistreatment. Distinguishing between appropriate treatment and inappropriate treatment that voids a warranty is often left to the subjective conclusion of an inspector or store clerk. Typically, there are three ways to determine product treatment surrounding warranties. The three methods and their shortcomings are as follows:
Tamper Evident Labels—These are only capable of measuring things such as whether or not a product was opened or water was spilled on the product. Discrete measurements at other levels may not be possible.
Warranty Trends Analysis—In this method, software is used to mine warranty data. It is able to determine trends such as a consumer returning more products than the statistical mean. However, it is unable to determine fraud on a particular product. Instead, it can only determine trends and alert to the possibility of fraud. Warranty trends analysis also does not address whether or not to reject a claim until after several steps of processing have been completed.
Manual Inspection—Inspectors are used to manually determine claim validity for a product. This is expensive, time consuming, and inaccurate. Inspections are often limited to the visible damage an item has received.

Therefore, there exists a need in the art for systems and methods that facilitate the determination whether a warranty is valid for a product based on actual product treatment.

### BRIEF SUMMARY OF THE INVENTION

The present invention provides methods and systems for obtaining and analyzing data from embedded sensors in electronic products for warranty management.

With one aspect of the invention, a data collection unit in an electronic product collects and reports data about environmental factors that is relevant about a warranty agreement. The data collection unit transmits the data through a transmitter over a communications link to a data interpretation unit. The transmitter supports a communication channel, including a radio link, photonic link, intra-red link, wired channel, and a cable link.

With another aspect of the invention, a data interpretation unit obtains warranty information from an electronic product and queries a database to determine if the electronic product has been exposed to environmental factors outside the ranges that are specified in the warranty agreement. If so, the warranty claim is determined to be invalid.

With another aspect of the invention, a data interpretation unit obtains sensor data and product information from an electronic product. The data interpretation unit queries a database to determine the product grade of the electronic product based on the sensor data.

With another aspect of the invention, a data interpretation unit obtains sensor data and product information from an electronic product. The data interpretation unit queries a database to determine an estimated product value based on the condition of the electronic product and relevant product values including a suggested retail price and a historical resale value.

With another aspect of the invention, a data interpretation unit obtains sensor data and product information from an electronic product. The data interpretation unit queries a database to determine an estimated warranty cost of an extended warranty based on the condition of the electronic product and relevant product values including a suggested warranty price and a historical warranty value.

With another aspect of the invention, a data interpretation unit obtains sensor data and product information from an electronic product as the electronic product is being manufactured. The information may be stored in a database for subsequent analysis. The stored data is analyzed to determine whether there are any quality assurance issues during the manufacturing process.

With another aspect of the invention, a data interpretation unit obtains sensor data and product information from an electronic product if the electronic product malfunctions. The information is analyzed for cases in which exposed environmental factors do not exceed limits specified by a warranty. The data interpretation unit analyzes the information in order to determine the cause of the malfunction.

With another aspect of the invention, a user exchanges collected sensory data with others, e.g., a manufacturer, retailer, or vendor. With the data exchange service, the collected information may be considered a commodity which is bought and sold.

With another aspect of the invention, a data interpretation unit obtains warranty information from an electrical product and queries a database to determine if a degree of usage of the electrical product exceeds a usage limit that is specified in the warranty agreement. If so, the warranty claim is determined to be invalid.

### BRIEF DESCRIPTION OF THE DRAWINGS

The present invention is illustrated by way of example and not limited in the accompanying figures in which like reference numerals indicate similar elements and in which:

FIG. 1 shows an architecture for embedding sensors in an electronic product in accordance with an embodiment of the invention.

FIG. 2 shows a data collection module in an electronic product in accordance with an embodiment of the invention.

FIG. 3 shows a flow diagram for a process that determines whether a warranty is valid for an electronic product in accordance with an embodiment of the invention.

FIG. 4 shows a flow diagram for a process that determines an estimate for a product grade of an electronic product in accordance with an embodiment of the invention.

FIG. 5 shows a flow diagram for a process that determines a product value estimate for an electronic product in accordance with an embodiment of the invention.

FIG. 6 shows a flow diagram for a process that determines an extended warranty cost estimate for an electronic product in accordance with an embodiment of the invention.

FIG. 7 shows a flow diagram for a process that indicates a quality assurance issue of an electronic product according to an embodiment of the invention.

FIG. 8 shows a flow diagram for a process that determines a cause of a malfunction of an electronic product in accordance with an embodiment of the invention.

FIG. 9 shows a flow diagram for a process that determines usage by detecting electrical current consumed by an electrical product in accordance with an embodiment of the invention.

### DETAILED DESCRIPTION OF THE INVENTION

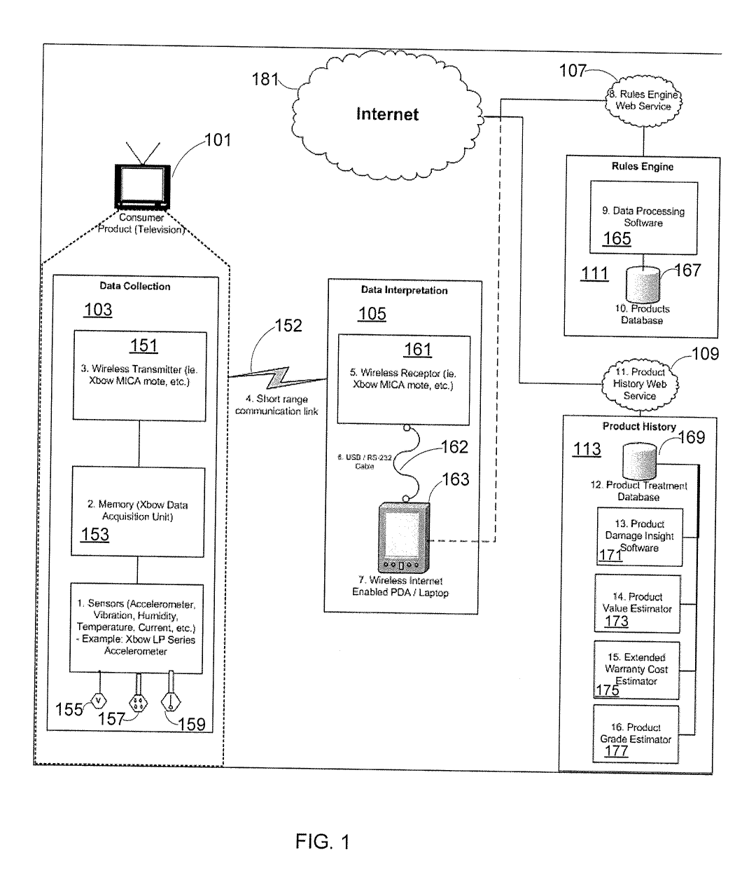

FIG. 1 shows an architecture for embedding sensors in an electronic product in accordance with an embodiment of the invention. The apparatus shown in FIG. 1 supports numerous scenarios related to obtaining and processing warranty data. FIG. 1 illustrates data collection unit 103, data interpretation unit 105, rules engine 111, and product history unit 113.

Data collection unit 103 includes sensors 155-159, data acquisition unit 153, and transmitter 151. Sensors 155-159 may be integrated with an electronic product (e.g., television 101) by embedding sensors 155-159 in the electronic product or by attaching sensors 155-159 to the electronic product. (The architecture shown in FIG. 1 supports different types of communication links including radio channels, photonic channels, cable channels, and wired channels. Also, the Internet, e.g., Internet 181, may be utilized to provide communications between transmitter 151 and data interpretation unit 105.) Data collection unit 103 records the treatment history of an electronic product (e.g., television 101). In addition, warranties may have measurable thresholds to define “normal usage”. By tracking treatment history and being able to determine “normal usage”, a manufacturer may have improved quality assurance, reduced warranty fraud, and new warranty offerings.

The architecture shown in FIG. 1 offers measurable thresholds (corresponding to specified environmental factors) to define warranties. Using thresholds may result in shorter claim processing times as well as improved visibility into product treatment history of television 101. Consequently, fraudulent warranty claims may be reduced by knowing the environmental conditions that television 101 has been exposed to. In addition to determining warranty fraud, the architecture in FIG. 1 provides data that is captured and mined for uses other than warranty validation. New warranty offerings, improved product quality, and dynamic resale value are exemplary uses for product treatment data that is collected by data collection unit 103.

Data acquisition unit 153 receives and stores sensor data from sensors 155-159 and records treatment of television 101. Product treatment history data that is collected by data acquisition unit 153 and stored in product treatment database 169 may support the following:
Warranty Fraud (manufacturer)—Post-sale data from embedded sensors 155-159 is used to determine mishandling at a consumer level. When a customer returns the product, sensors 155-159 can be checked to determine if the consumer has voided his/her warranty through mistreatment of the equipment. This reduces the number of fraudulent warranty claims and provides tangible metrics around warranty claims.
Warranty Fraud (aftermarket)—Sensors 155-159 are placed on or in consumer products (e.g., television 101) at a retail store to provide new warranty offerings. Retailers or warranty vendors can begin to run unique “extended warranty” programs that take into consideration both time and product treatment.
Quality Assurance—Environmental data from embedded sensors 155-159 is fed back to a manufacturer. This data can be processed in product damage insight software 171 to determine assembly, handling or storage issues within the manufacturer's plant or with the manufacturer's distribution system.
Service History—Sensors 155-159 are placed on consumer products that may be resold. The measurements from sensors 155-159 may be used to determine the treatment of the product. Since not all products are treated equally, potential buyers have metrics around the quality of the products they purchase. In addition, manufacturers can use the mined data to offer new types of variable price and length warranties in addition to using the data to improve future product design.

Sensors 155-159 and data acquisition unit 153 provides greater product treatment visibility to the manufacturer and the retailer. The acceptance or rejection of warranty claims may be determined from metrics measured by sensors 155-159 as opposed to visible damage conclusions, which are open to interpretation, of current inspectors. Product treatment thresholds and rules within data processing software 165 and products database 167 provide “regular usage” standards for specific products and their warranties. New types of warranty offerings that are not just time-based, but also treatment-based, may be offered. Warranties may be defined by measurable thresholds. Product damage insight software 171 uses tangible metrics as insight, as mined from product treatment data, to determine possible causes of failures. Sensors 155-159, in conjunction with data acquisition unit 153, may be used to provide product treatment history. Product value estimator 173 uses data from product treatment database 169 to determine an estimated value of the electronic product based on prior treatment.

Using sensors 155-159 embedded in an electronic product (e.g., television 101) enables a manufacturer to create an audit trail about product treatment. Consequently, the manufacturer may obtain a better insight into electronic products throughout their life cycle resulting in improved quality assurance, reduced warranty fraud, and new warranty offerings. Sensors 155-159 may detect environmental properties such as:
Shock/acceleration (drops or impacts)
Humidity (Spills/water damage)
Temperature (Storage or usage in extreme environments)

The architecture shown in FIG. 1 also supports embodiments in which a user exchanges collected data with others. With some embodiments (e.g., a sensor data exchange service), information may be considered a commodity which is bought and sold. A user may also trade some of the collected information for new services.

A sensor data exchange service gives participating parties reasons to mine the collected data and ensures that consumers will also find benefits in sharing the collected data by sensors 155-159. In effect, it is an open market to buy and sell data. The consumer data exchange service provides the following benefits:
Consumer Benefit:
   Uploading sensor data (through the consumer's PC) provides a simple approach for consumers to purchase extended warranty directly from the manufacture
   Consumers can also check on the current treatment of their product to determine if there existing warranty has been voided
   Consumers can validate the good treatment of their product—allowing them to charge a premium for product in a second-hand market (EBay etc.)
Manufacturer Benefit
   Manufacturer will get data back about how their product is used in the real world (data not currently available)
   Manufacturers are given a touch point with potential consumers by enabling them to offer lucrative new services such as extended warranty
   When a consumer sells used electronic products and uses a certificate of treatment for verification of product handling, manufacturers have new touch point for subsequent owners with offered services.
   Brand Differentiation: New consumer services differentiate brands and create brand loyalty. Consequently, the manufacturer may charge a premium for products.

Sensors 155-159 may be placed in electronic products at a manufacturer or retail level. Even though a user may regularly use their electronic products, stored sensor data can be later uploaded. Consumers wishing to benefit from sharing transparently captured knowledge may log on a data exchange service. Consumers select from various companies interested in their sensor data. For example, consumer benefits are listed for each company type. These benefits may range anywhere from product discounts to the ability to use company-wide data to determine things such as resale value of the consumer's product. Consumers select a benefit type and upload the product data. The consumer receives his/her desired benefit. The selected company receives the consumer data for later use. An exemplary scenario includes:

1. Sensors 155-159 are placed in products at a manufacturer or retail level.

2. The user watches movies on his/her DVD player. This player's memory stores the types of movies, frequency of use, and times of use during its lifetime. In addition, a sensor in the player records any shocks that occur.

3. User plugs player into Internet-enabled home computer.

4. User logs on to a data exchange service web page.

5. User sees advertising that both the manufacturer of DVD player and a movie rental store are interested in information stored on the user's player.

6. User clicks on movie rental store benefits. Movie rental store offers free movie rental for uploading one month's worth of movie history.
User uploads movie rental information and receives a free rental voucher.
The movie rental company can now determine what types of movies that this person likes to watch based on the movie history of the user.

7. User clicks on manufacturer benefits. Manufacturer offers a 10% discount on next purchase of manufacturer's product and unlimited use of product value estimator (estimates current market value of a product based on product treatment) if the user uploads shock sensor data.
User uploads sensor data and receives 10% off voucher and access to the product value estimator run by the manufacturer.
User is also offered an option to purchase extended warranty (price based on the treatment and age of the product)
User is also offered a digital certificate to verify product treatment that can be used in a sale of the product. For example, the digital certificate may be a unique number that can be handed on another person to verify results on the manufacturer site.
The manufacturer can now use the user's product treatment history to determine real-world usage of products. This usage history can assist in future product designs.
The manufacturer now has a new touch point with consumers to offer new services.

An exemplary embodiment indicates whether there is a quality assurance issue in the manufacture of an electronic product. Environmental data from embedded sensors 155-159 are fed back to a manufacturer. This data can be used to determine assembly, handling, or storage issues within the manufacturer's plant or with the manufacturer's distribution system.

The operation of a computer, as may be contained in data acquisition unit 153, PDA 163, rules engine 111, and product history unit 113, may be controlled by a variety of different program modules. Examples of program modules include routines, programs, objects, components, and data structures that perform particular tasks or implement particular abstract data types. The present invention may also be practiced with other computer system configurations, including hand-held devices, multiprocessor systems, microprocessor-based or programmable consumer electronics, network PCS, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

An exemplary embodiment supports a consumer electronics manufacturer that determines that a large number of its plasma screen televisions are non-functional out of the box. Embedded sensor data indicates collisions are happening often on the manufacturing assembly line, when the product is most sensitive to environmental factors. The manufacturer is able to quickly resolve the issue and avoid future costs.

Data collection unit 103 is placed on the chassis of electronic product 101 (e.g., television) at start of manufacturing process. The manufacturing process involves product diversions into a series of bins during assembly phases. The bins, for example, are approximately 3 feet deep and unpadded. In an exemplary scenario, sensors 155, 157, and 159 detect multiple collisions of 3 Gs, where 1 G corresponds to the force of gravity at sea level. (For example, sensors 155-159 may include an accelerometer.) Data acquisition unit 153 stores a history of collisions for later retrieval. Data acquisition unit 153 may include associated time stamp information to associate the time of a measurement with the event.

Embodiments of the invention support different types of sensors. For example, sensors 155-159 may measure environmental factors including impacts/shock (accelerometer), humidity, moisture, temperature, chemical contamination, magnetic exposure, pressure, and customer tampering.

In the embodiment, sensors 155-159 are not easily accessible by one who is not authorized. With respect to the consumer, sensors 155-159 are tamper-proof so that the consumer cannot alter the measurements to circumvent the warranty agreement. For example, if the consumer attempts to alter or disable a sensor, any attempt is recorded in memory acquisition unit 153. In an embodiment, sensor data is encrypted so that only authorized personnel can read the encrypted sensor data.

During the exemplary scenario, the manufacturing process is completed, and embedded sensor data is reviewed for internal quality assurance. Wireless transmitter 151 communicates collision data from data acquisition unit 153 via communications link 152 to a wireless receptor 161. For example, communications link 152 may support Bluetooth, which utilizes a short-range radio link to exchange information, enabling effortless wireless connectivity between mobile phones, mobile PCs, handheld computers and other peripherals. (An objective of Bluetooth is to replace the IrDA spec of InfraRed in mobile and computing devices.)

Wireless Internet-enabled personal digital assistant (PDA) 163 receives raw data via communication cable 162 and transmits data to the product history web service 109. Product treatment database 169 updated via exposed product history web service 109 through the Internet 181 to keep audit trail of product treatment. Product damage insight software 171 interprets product treatment database 169 data and determines that product malfunction likely due to a collision while television 101 is on the assembly line. Product damage insight software 171 alerts the manufacturer of a possible quality assurance issue. The manufacturer corrects the collision issue in the manufacturing process by padding diversion bins.

In the above scenario, the manufacturer may not have good visibility into product treatment within the manufacturing facility. Sensors 155-159 and data acquisition unit 153 may be used to improve product treatment visibility. Product damage insight software 171 uses tangible metrics as insight, as mined from product treatment data, to determine cause of failures.

With another exemplary embodiment, post-sale data from an embedded sensor is used to determine mishandling of the product at a consumer level. When a customer returns the product the sensors can be checked to determine if a consumer has voided his/her warranty through mistreatment of the product. This reduces the number of fraudulent warranty claims and provides tangible metrics around warranty claims. For example, a consumer purchases a plasma television 101 from a large retailer. While plasma television 101 is still under warranty, the customer accidentally drops the television. The screen remains intact, and there is no visible damage to television 101. However, television 101 does not work and is returned to the retailer. The retailer uses the implanted sensor data to determine that the warranty was voided because television 101 underwent a large shock while in the consumer's possession. The manufacturer is therefore able to avoid a fraudulent warranty claim.

In the scenario, data collection unit 103 is placed in consumer product (television 101) at manufacturer. A consumer subsequently purchases television 101. The consumer drops television 101 before warranty period expires. Sensors 155-159 detect a collision of 10 Gs. Data acquisition unit 103 stores the history of collisions for later retrieval. The consumer begins the warranty claim process. An inspector begins the inspection process to deny or accept claim. Wireless transmitter 151 communicates collision data from data acquisition 153 via communications link 152 to wireless receptor 161. Wireless Internet-enabled PDA 163 receives raw data via communication cable 162 and transmits data via the Internet 181 to rules engine web service 107 for interpretation. Data processing software 165 processes raw data as inputs to begin processing the warranty. Data processing software 165 references products database 167 to determine rules and thresholds for given a consumer product (e.g., television 101). Data processing software 165 determines that the warranty is void beyond an impact threshold of 5 Gs. Wireless Internet-enabled PDA 163 receives warranty claim results and indicates that the warranty may be voided. The inspector denies the warranty claim because the collision occurred after purchase date on receipt. Product treatment database 169 is updated via exposed product history web service 109 to keep an audit trail of product treatment.

Currently, manufacturers do not have visibility into product treatment beyond the manufacturing facility. Sensors 155-159, in conjunction with data acquisition unit 153, may be used to provide product treatment visibility. The acceptance or rejection of warranty claims is determined from metrics measured by sensors 155-159 as opposed to visible damage conclusions, which are open to interpretation, of current inspectors. Product treatment thresholds and rules within data processing software 165 and products database 167 provide “regular usage” standards for specific products and their warranties. Warranty agreements are specified by measurable thresholds.

With another exemplary embodiment, sensors 155-159 are placed on or in electronic products at a retail store and may enable the retailer to sell new warranty offerings. Retailers or warranty vendors can begin to run unique “extended warranty” programs that take into consideration both time and product treatment. In an exemplary scenario, a consumer purchases plasma television 101 from a large retailer. The consumer purchases the embedded sensor warranty that lasts either X years or until the user exceeds the mishandling threshold (determined by shock sensor data). When the consumer makes a claim, sensors 155-159 can then be checked to ensure the damage is not due to a misuse of the product.

The consumer purchases television 101 and “5 year or 5 Gs” warranty (void after 5 years or if accelerometer data indicates an impact greater than 5 Gs). Data collection unit 103 is attached to television 101 by the retailer. In the exemplary scenario, the consumer drops television 101 before the warranty period expires. Sensors 155-159 detect a collision of 10 Gs. Data acquisition unit 103 stores the history of the collision for later retrieval. The consumer begins the warranty claim process. An inspector begins the inspection process to deny or accept claim. Wireless transmitter 151 communicates collision data from data acquisition unit 153 via communications link 152 to wireless receptor 161. Wireless Internet-enabled PDA 163 receives raw data via communication cable 162 and transmits data via the Internet 161 to the rules engine web service 107 for interpretation. Data processing software 165 processes raw data as inputs to begin processing a warranty claim. Data processing software 165 references products database 167 to determine rules and thresholds for given electronic product (television 101). Products database 167 determines that the warranty is void beyond an impact threshold of 5 Gs. Wireless Internet-enabled PDA 163 receives warranty claim results and indicates that the warranty is void. The inspector denies the warranty claim because the collision occurred after purchase date on receipt. (For example, a time stamp may be associated with the sensor measurement.) Product treatment database 169 is updated via exposed product history web service 109 to keep an audit trail of product treatment.

In the above scenario, a retailer may not have visibility into product treatment beyond the retail store. Sensors 155-159, in conjunction with data acquisition unit 153, provide product treatment visibility. The acceptance or rejection of warranty claims is determined from metrics measured by sensors 155-159 as opposed to visible damage conclusions, which are open to interpretation, of current inspectors. Product treatment thresholds and rules within data processing software 165 and products database 167 provide “regular usage” standards for specific products and their warranties. New types of warranty offerings, which are not just time based but also treatment based, may be offered by the retailer. Warranties may be defined by measurable thresholds.

With another exemplary embodiment, sensors 155-159 are placed on electronic products, which may be resold, to determine the treatment of the product. Since not all products are treated equally, potential buyers are able to obtain metrics that are indicative of the quality of the products that they purchase. In addition, manufacturers can begin to use the mined data to offer new types of variable price and length warranties in addition to using the data to improve future product design. In an exemplary scenario, a consumer purchases television 101. A sensor 155-159 is placed in television 101 to determine whether or not television 101 has been mishandled. When the consumer decides to sell television 101, the buying party is able to use the embedded sensor data to determine how well television 101 was treated and see an estimated product value. The purchaser can use this treatment data and estimated product value to decide on an appropriate resale value.

Data collection unit 103 is placed in a consumer product (television 101) at the time of purchase. In the exemplary scenario, the consumer drops television 101 during ownership. Sensors 155-159 detect a collision of 2 Gs. Data acquisition unit 153 stores a history of collisions for later retrieval. The consumer decides to resell product via online auction service. The consumer begins the process to upload product treatment history. Wireless transmitter 151 communicates collision data from data acquisition unit 153 via communications link 152 to wireless receptor 161. Wireless Internet-enabled PDA 163 receives raw data via communication cable 162 and transmits data via the Internet to the product history web service 109. Product history web service 109 enters data in product treatment database 169. The potential buyer views television 101 through an auction service. The potential buyer begins the process to view the product treatment history of the previous owner. The auction service performs a query of the television history through product history web service 109. Product history web service 109 returns television treatment history from product treatment database 169. Product value estimator 173 uses product treatment database 169 data to determine the estimated value of the product based on prior treatment. Television treatment history and the estimated product value are viewed on the potential buyer's display via the auction service. The potential buyer bases the item value on the television treatment history and the value derived from product value estimator 173.

In another exemplary scenario, a manufacturer has embedded a sensor in television 101 to determine causes of product failures. A consumer purchases television 101 and later returns it due to a malfunction. The embedded sensor data from sensors 155-159 is analyzed. It is determined that the cause of the malfunction is vibration of the television 101 causing a third party component to fail, despite operating within normal thresholds (i.e., no collected data is above the collision threshold). The third party component vendor is held accountable for the quality of its parts. The manufacturer receives compensation for component defects, and the vendor corrects the vibration issue.

In the above exemplary scenario, data collection unit 103 is placed in the consumer product (television 101) by the manufacturer. A consumer purchases television 101, and vibration occurs during regular usage. Sensors 155-159 detect excessive vibration. Data acquisition unit 153 stores the history and strength of the vibrations for later retrieval. The product subsequently malfunctions. The consumer begins the warranty claim process. An inspector begins the inspection process to deny or accept claim. Wireless Internet-enabled PDA 163 receives raw data via communication cable 162 and transmits data via the Internet to rules engine web service 107 for interpretation. Data processing software 165 processes raw data as inputs to begin processing the warranty claim. Data processing software 165 accesses products database 167 to determine rules and thresholds for the consumer product (television 101). Data processing software 165 determines that the warranty is valid since the vibrations are within operating thresholds. Wireless Internet-enabled PDA 163 receives the warranty claim results and indicates that the warranty claim is accepted. The inspector accepts the warranty claim. Product treatment database 169 is updated via exposed product history web service 109 to keep an audit trail of the product treatment. Product damage insight software 171 mines data in product treatment database 169 and determines that many returns have occurred due to excessive vibration. The manufacturer is notified of the likely defect cause. The manufacturer determines that a third party component is likely to fail when exposed to vibration, despite operating within normal thresholds. The third party vendor is held accountable and corrects the identified vibration issue. The manufacturer receives compensation for component defects.

In another exemplary embodiment, a consumer has purchased television 101 with embedded sensors 155-159. The original warranty is for one year and the consumer decides not to purchase an extended warranty at time of purchase. However, after one year, the consumer decides to purchase an extended warranty. The consumer is able to upload current embedded sensor data to get a dynamic extended warranty price and coverage terms based on the product's treatment history.

In the above scenario, data collection unit 103 is placed in the consumer product (television 101) by the manufacturer. A consumer purchases television 101. Minor collisions occur during regular usage over a one-year warranty lifecycle. Sensors 155-159 detect each collision. Data acquisition unit 153 stores the history and strength of collisions for later retrieval. The warranty expires, and the consumer decides to purchase a dynamically price, extended warranty. The consumer uploads embedded sensor data as input to a warranty offering. Wireless transmitter 151 communicates collision data from data acquisition unit 153 via communications link 152 to wireless receptor 161. Wireless Internet-enabled PDA 163 receives raw data via communication cable 162 and transmits data via the Internet 181 to extended warranty cost estimator 175 for the expected warranty cost. Collision data indicating greater impacts increases the baseline expected warranty cost. Wireless Internet-enabled PDA 163 receives warranty claim offer results and displays the results to the consumer. The consumer accepts the proposed warranty cost and conditions. Product treatment database 169 is updated via exposed product history web service 109 to keep an audit trail of the product treatment. Product damage insight software 171 mines data in product treatment database 169 and determines that many returns are occurring due to excessive vibration.

In the above scenario, purchasing consumers may not have visibility into product treatment history of the products they wish to purchase. Sensors 155-159, in conjunction with data acquisition unit 153, provide product treatment history. Product treatment thresholds and rules within data processing software 165 and products database 167 provide “regular usage” standards for specific products. Product value estimator 173 uses product treatment database 169 data to determine an estimated value of the product based on prior treatment with objective metrics rather than having the consumer haggle and negotiate the purchase price.

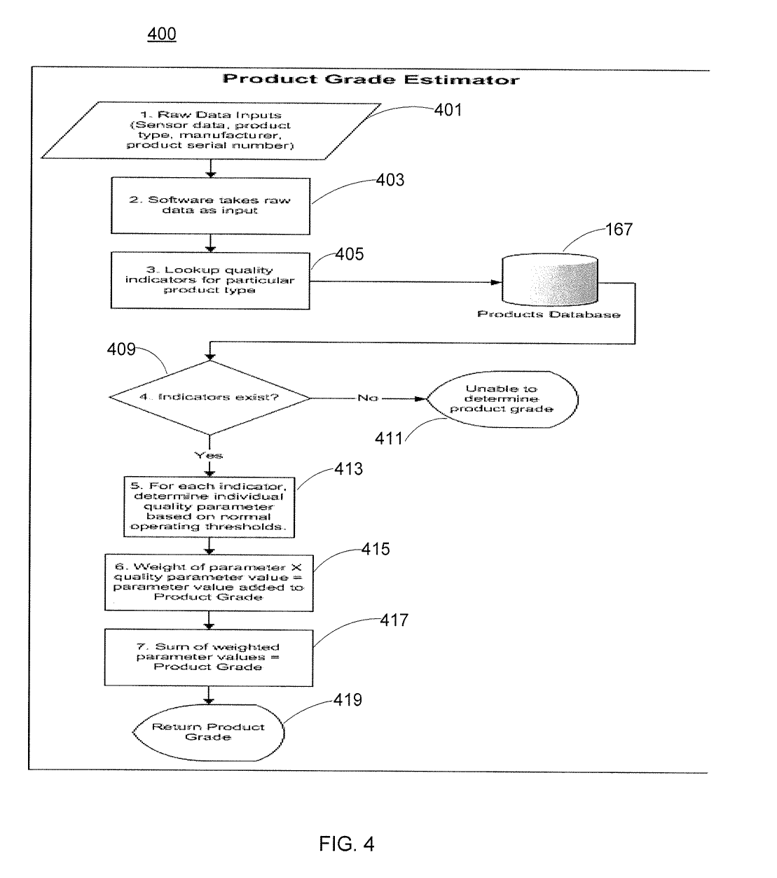

The architecture in FIG. 1 also supports the determination of the product grade of an electronic product as will be described with FIG. 4. Product grade estimator 174 supports this feature.

The architecture shown in FIG. 1 also supports a business model in which a third party certifies an electronic product. For example, an independent certification service may access sensor data from data acquisition unit 153 over communication link 152. If the independent certification service determines that the electronic product has not been exposed to environmental factors that exceed specified thresholds, the independent certification service issues a certificate verifying the condition of the electronic product. The owner can subsequently advertise that the electronic product has been certified when selling the product in order to increase its resale value.

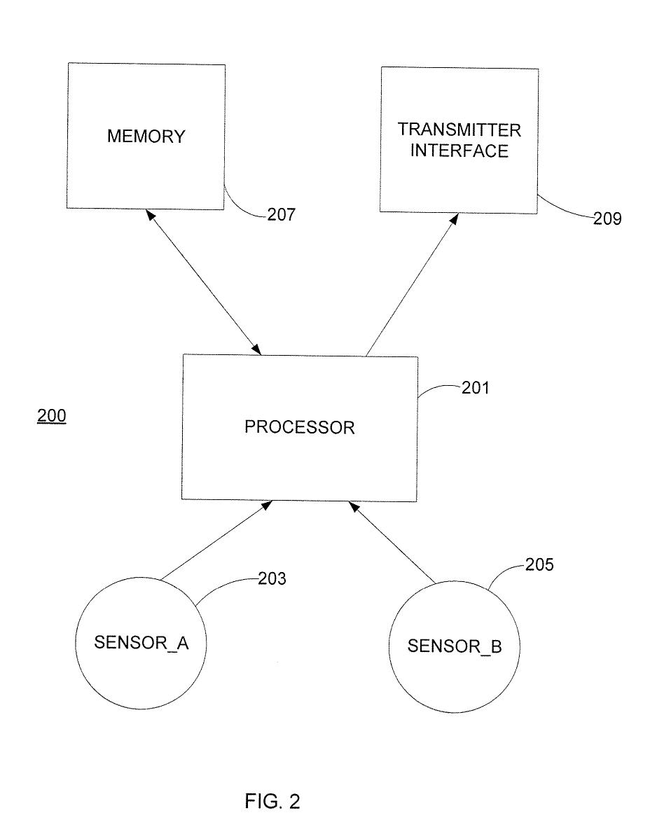

FIG. 2 shows a data collection unit 103 in an electronic product in accordance with an embodiment of the invention. Processor 201 collects sensor data from sensors 203 and 205 and may associate time stamps with the collected data. Collected data is stored in memory 207 for later retrieval. The retrieved data may be transmitted through transmitter interface over communications link 152 to data interpretation unit 105.

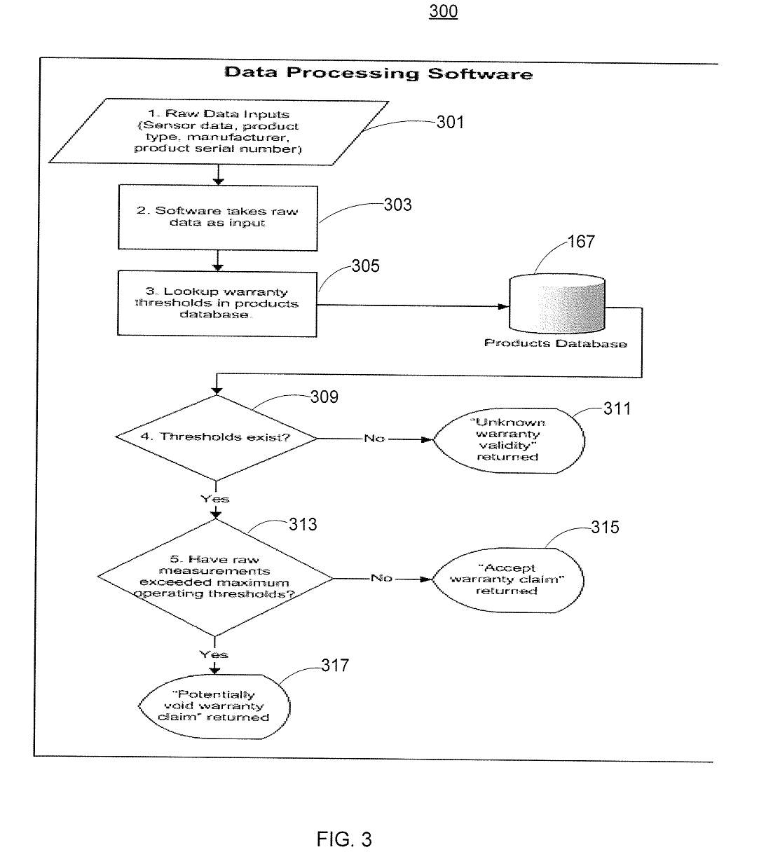

FIG. 3 shows a flow diagram for process 300 (Data Processing Software) that determines whether a warranty is valid for an electronic product in accordance with an embodiment of the invention. Data processing software 165 executes rules to determine whether or not a warranty has potentially been voided. A warranty for each sensor-enabled product has specified normal treatment thresholds. Sensor data (time and strength of humidity, temperature, impact, etc.) is processed according to product type, manufacturer, and product serial number of the electronic product. Process 300 determines whether a warranty is void or valid or whether the warranty has unknown validity.

In process 300, sensors 155-159 obtain environmental measurements, and data acquisition unit 103 stores appropriate information for later retrieval as data 301. In step 303, software processes sensor data and other parameters as inputs. In step 305, software looks up warranty thresholds in products database 167. (For example, any shock beyond 10 Gs for a hard drive voids the warranty.) Step 309 determines if thresholds have been established. If no thresholds have been established, then return a status of “unknown warranty validity” in step 311. For each type of threshold (i.e. acceleration, humidity, temperature, etc.) step 313 determines if the product exceeded the threshold. If at least one threshold is exceeded, a status of “potentially void warranty claim” is returned in step 317. Otherwise, a status of “accept warranty claim” is returned in step 315.

In an exemplary scenario, a sensor that is attached to a cell phone has captured the following data and has stored the data in memory: maximum shock=10 Gs of force (accelerometer) and maximum temperature=150 degrees Fahrenheit (thermometer). Process 300 obtains sensor data as well as the following parameters as input: manufacturer=Nokia, product type=3360 and serial number=0000 0001 as data 301. Step 305 looks up the following warranty thresholds for Nokia 3360 phones from the products database 167: maximum shock=4 Gs of force and maximum temperature=180 degrees Fahrenheit. Step 309 determines that thresholds indeed exist. Step 313 checks to see if any of the values of data 301 have exceeded the thresholds from step 305. In the exemplary scenario, the maximum shock threshold has been exceeded. Therefore, step 317 returns a status of “potentially void warranty claim”.

FIG. 4 shows a flow diagram for process 400 (Product Grade Estimator) that determines an estimate for a product grade of an electronic product in accordance with an embodiment of the invention. Process 400 uses sensor data to determine a quality grade of an electronic product. This quality grade is easy to understand by relating the quality grade to a scale from 0-100 with ‘0’ being the lowest quality grade and ‘100’ being the highest. Each electronic product may have a unique method of determining quality grade. For example, as an analogy, the number of highway miles versus city miles on a car's odometer affects the resale value (with mileage being the same, city miles lower the grade of a car more than highway miles). Similarly, an electronic product has identifiable and measurable quality indicators. Process 400 inputs sensor data, product type, manufacturer, and product serial number, while providing a product grade estimate.

In process 400, sensors 155-159 obtain environmental measurements, and data acquisition unit 153 stores appropriate information for later retrieval as data 401. Step 403 obtains sensor data and other parameters as inputs. In step 405, software accesses lookup quality indicators for particular product from database 167. Step 409 determines the existence of indicators in database 167. If there are no indicators, step 411 returns “unable to determine product grade”. For each indicator, step 413 determines a quality grade based on data input from the given sensor and normal operating thresholds (i.e., accelerometer data indicating an impact of 10 Gs for a product with a normal operating threshold of 1 G would receive a quality grade for impact in the lower portions of the quality scale). Unique algorithms may be determined for each parameter and item. In step 415 the parameters are weighted, in which weight of parameter in overall product grading times quality parameter value=weighted parameter value. In step 417, the weighted parameters are summed, where the sum of weighted parameter values=product grade. Step 419 returns the product grade (corresponding to product grade estimator 177 as shown in FIG. 1).

In an exemplary scenario, a sensor that is attached to a cell phone has captured the following data and stored the data in memory: maximum shock=10 Gs of force (measured by an accelerometer) and maximum temperature=150 degrees Fahrenheit (measured by a thermometer sensor). In step 403, software obtains sensor data 401 as well as the following parameters as input: Manufacturer=Motorola, Product Type=3360, Serial Number=0000 0001. The quality indicators for a cell phone correspond to shock and temperature according to the products database 167. If step 409 determines quality indicators exist, process 400 continues. A quality grade for each indicator is determined based on the data input from the given sensor and the normal operating thresholds. The following individual grades are given based on the grading algorithms: shock grade of 10 corresponding to 10 Gs of force (actual max) where 4 Gs of force (max threshold) and 0 Gs (min threshold) and a temperature grade of 70 corresponding to 150 degrees Fahrenheit (actual max) where 180 degrees Fahrenheit (max threshold) and 30 degrees Fahrenheit (min threshold). A weight for each parameter is determined from products database 167 for this particular type of product. Shock is given a weight of 0.667. Temperature is given a weight of 0.333. Weighted shock parameter=(0.667)×(10)=6.67. Weighted temperature parameter=(0.333)×(70)=23.31. Sum of weighted parameter values=6.7+23.3=30 (product grade). Process 400 returns product grade of 30 out of 100.

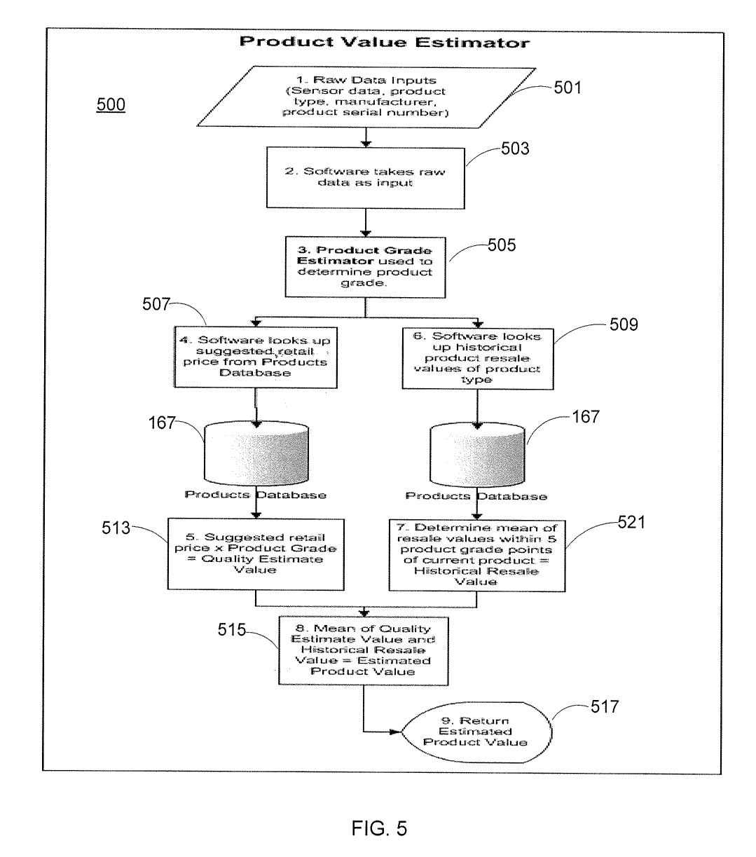

FIG. 5 shows a flow diagram for process 500 (Product Value Estimator) that determines a product value estimate for an electronic product in accordance with an embodiment of the invention. Process 500 uses sensor data and historical resale values to determine an estimated value for a particular product. Since item treatment and overall condition determines product value, using embedded sensor data can provide accurate and unbiased value estimates. Process 500 inputs sensor data (e.g., humidity, temperature, impact, etc.), product type, manufacturer, and product serial number, while providing the estimated product value for the electronic product.

Sensors 155-159 obtain environmental measurements, and data acquisition unit 103 stores appropriate information 501 for later retrieval. In step 503, software obtains sensor data and other parameters as input. Step 505 determines a numeric value between 0 and 100 for the treatment of this particular product. A value of ‘0’ represents the lowest grade. A value of ‘100’ represents the highest grade. In step 507, software looks up suggested retail price from products database 167. In step 513, the quality estimate value=suggested retail price times product grade. In step 509, software looks up the historical product resale values for the product type from products database 167. Step 521 determines the mean of all resale values within 5 product grade points of current product, which represents the historical resale value. The mean of the quality estimate value and the historical resale value represents the estimated product value. Step 517 returns the estimated product value.

In an exemplary scenario, a sensor that is attached to a cell phone has captured the following data and stores the data in memory: maximum shock=10 Gs of force (accelerometer) and maximum temperature=150 degrees Fahrenheit (thermometer). Software takes sensor data as well as the following parameters as inputs: manufacturer=Nokia, product type=3360, and serial number=0000 0001. Process 500 returns a treatment value of 30 (below average) for the treatment of this particular product. Software looks up the suggested price from the products database. The suggested retail price for this particular phone is $100. Suggested retail price ($100) times product grade (30/100)=quality estimate value ($30). Software looks up historical product resale values for the Nokia 3360. The mean of all resale values of the Nokia 3360 with product grades between 25-35 is $40, which is the historical resale value. The mean of the quality estimate value ($30) and the historical resale value ($40) is $35. This value represents the estimated product value. Process 500 returns the estimated product value ($35).

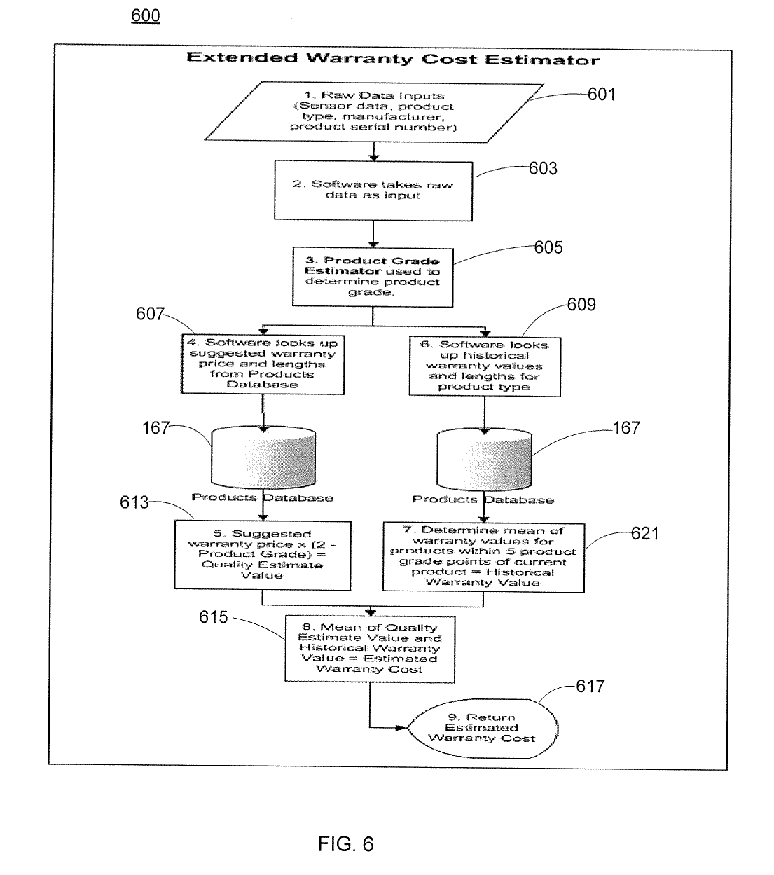

FIG. 6 shows a flow diagram for process 600 (Extended Warranty Cost Estimator) that determines an extended warranty cost estimator for an electronic product in accordance with an embodiment of the invention. Process 600 uses sensor data to determine cost and associated warranty lengths for insuring a particular product. Since electronic products are often likely to live beyond their original warranty lifetime, improved product treatment may result in low cost extended warranties. This opportunity may open up new sources of revenues for manufacturers, retailers, and others in the warranty industry. Process 600 inputs sensor data (e.g., humidity, temperature, impact, etc.), product type, manufacturer, product serial number, while providing valid warranty lengths and associated warranty prices.

In process 600, sensors 155-159 obtains environmental measurements and data acquisition unit 103 stores appropriate information 601 for later retrieval. In step 603, software obtains sensor data and other parameters as input. In step 605 determines a numeric value between 0 and 100 for the treatment of this particular electronic product. A value of ‘0’ represents the lowest grade. A value of ‘1100’ represents the highest grade. In step 607 software looks up suggested warranty price from products database 167. In step 613, quality estimate value=suggested warranty price times (2−product grade). In step 609, software looks up historical warranty values and lengths for the product type from database 167. Step 621 determines the mean of all warranty values within 5 product grade points of current product, which represents the historical warranty value. In step 615, the mean of the quality estimate value and the historical warranty value represents the estimated warranty cost. Step 617 returns the estimated warranty cost.

In an exemplary scenario, a sensor that is attached to a cell phone has captured the following data and stores the data in memory: maximum shock=10 Gs of force (accelerometer) and maximum temperature=150 degrees Fahrenheit (thermometer). Software takes sensor data as well as the following parameters as inputs: Manufacturer=Nokia, product type=3360 and serial number=0000 0001. Process 600 returns a treatment value of 30 (below average) for the treatment of this particular product. Software looks up the suggested warranty price from the products database 167. The suggested warranty price for 1 year is $10 for this cell phone. Suggested warranty price ($10) times (2−product grade (30/100))=quality estimate value ($17). Software looks up historical one-year warranty values for the Nokia 3360. The mean of all warranty sale values of the Nokia 3360 with product grades between 25-35 is $25, which is the historical warranty value. The mean of the quality estimate value ($17) and the historical warranty value ($25) is $21. This value represents the estimated warranty cost. Step 617 returns the estimated warranty cost ($31).

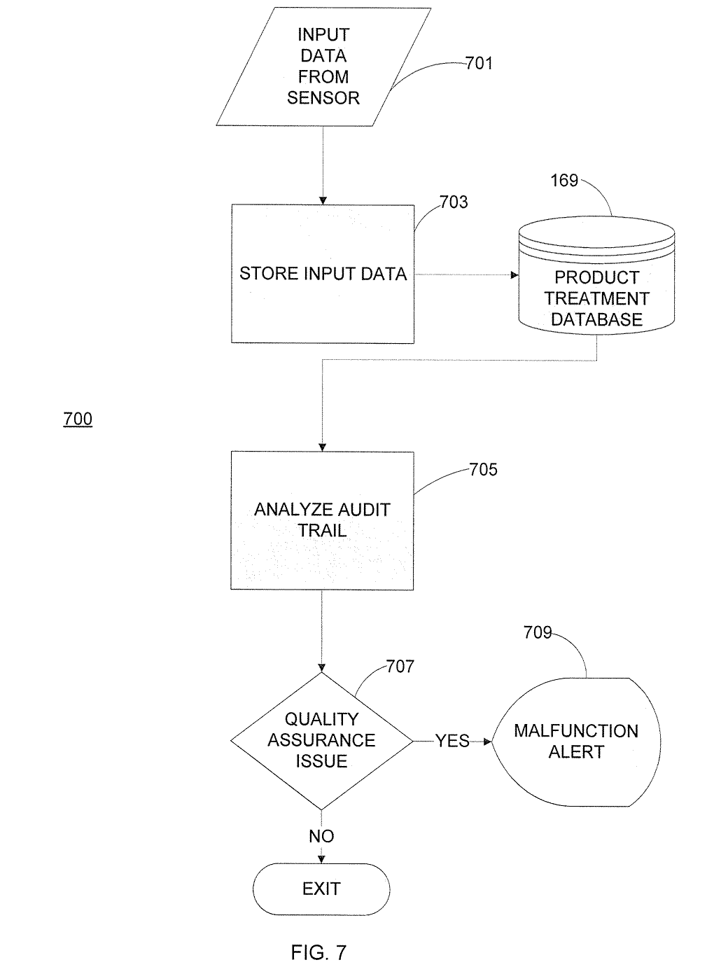

FIG. 7 shows a flow diagram for process 700 that indicates a quality assurance issue of an electronic product according to an embodiment of the invention. Process 700 determines whether there is a quality assurance issue in the manufacture of an electronic product. Environmental data from the embedded sensor is fed back to a manufacturer. This data can be used to determine assembly, handling or storage issues within the manufacturer's plant or with the manufacturer's distribution system.

Input data 701 from sensors 155-159 are obtained and stored in step 703. For example, input data 701 may include collision and time stamp information associated with the time with the event. The input data is stored into product treatment database 169.

Step 705 interprets data from product treatment database 169 and determines whether a product malfunction likely due to an environmental factor while the electronic product is being manufactured on the assembly line. Step 707 alerts manufacturer of possible quality assurance issue in step 709. Consequently, the manufacturer can correct the environmental problem in the manufacturing process.

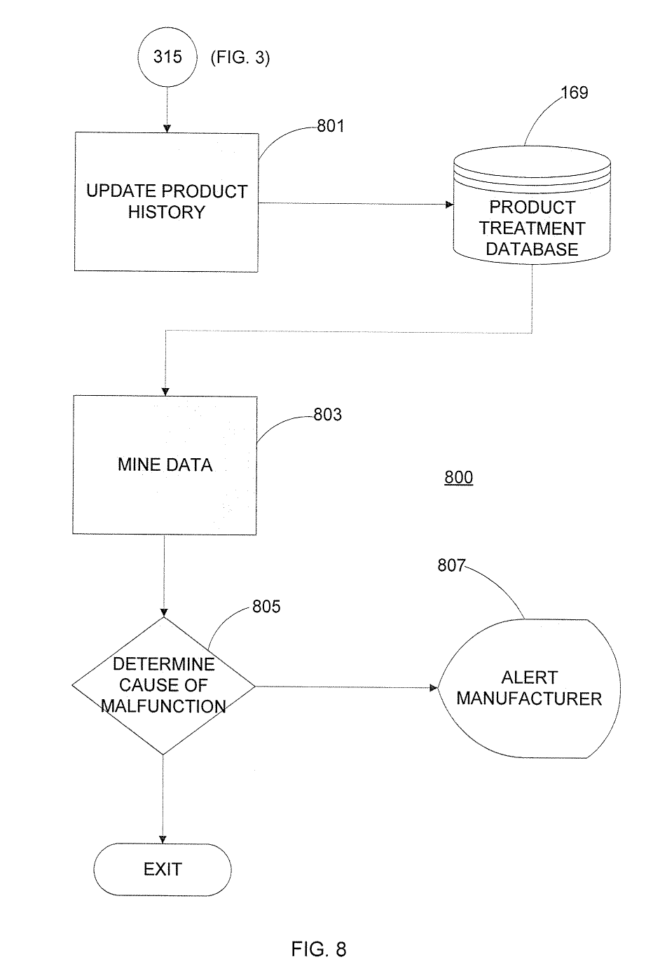

FIG. 8 shows a flow diagram for process 800 that determines a cause of a malfunction of an electronic product in accordance with an embodiment of the invention. If a warranty claim is accepted in step 315 (as shown in FIG. 3), sensor data is collected stored in product treatment database 169.

In step 803 data is mined from product treatment database 169 to determine if a malfunction is caused by an environmental factor that does not void a warranty. (For example, frequent product malfunctions may be caused by low-intensity vibrations.) If so, as determined by step 805, the manufacturer is alerted in step 807.

Processor 201 (as shown in FIG. 2) obtains usage information (e.g., electrical power usage) of an electrical product (which be an electronic product, e.g., a DVD player or an electrical appliance, e.g., a washing machine) in order to determine an actual usage of the electrical product. In an embodiment of the invention, sensor 203 monitors an amount of electrical current that is consumed by the electrical product and consequently determines a mode of operation. For example, a DVD player may include an embedded device that monitors usage (as well as environmental factors and misuse). If the consumed electrical current is below a first value, then processor 201 determines that the DVD is inactive. If the consumed electrical current is above the first value and below a second value, then processor 201 determines that the DVD is in the stand-by mode. If the consumed electrical current is above the second value, then processor 201 determines that the DVD is in the play mode. The above approach may be applied to other types of appliances, including refrigerators, washing machines, computers, and so forth.

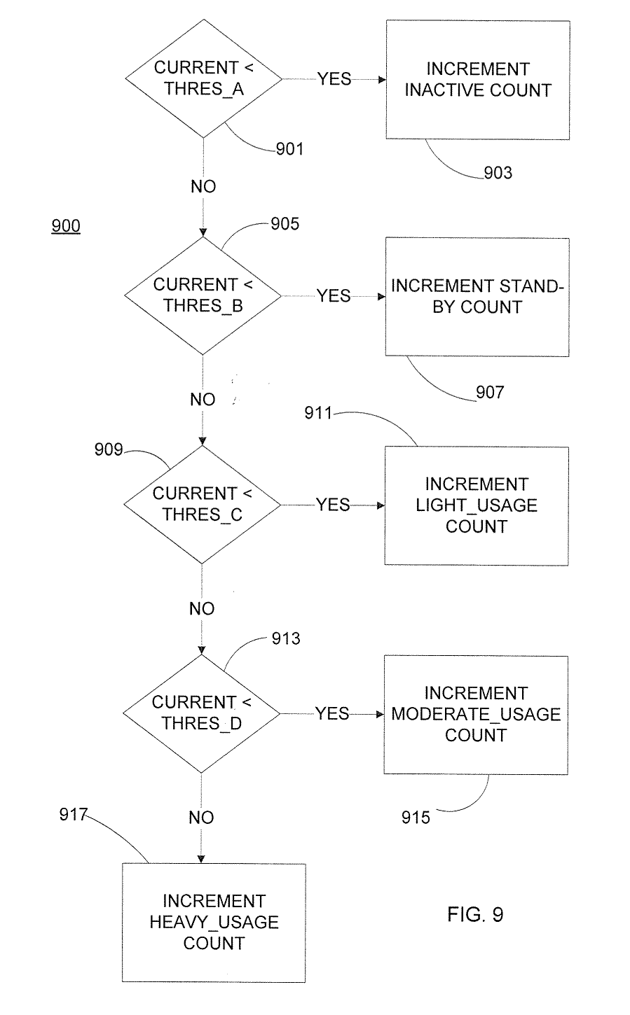

FIG. 9 shows flow diagram 900 for a process that determines usage by detecting electrical current consumed by an electrical product in accordance with an embodiment of the invention. (In the embodiment, the process is executed periodically every T seconds.) Step 901 detects if the electrical current (which is related to the electrical power) consumed by an electrical product is less than THRESHOLD_A. If so, an INACTIVE counter is incremented in step 903. If not, then step 905 detects if the consumed electrical current is less than THRESHOLD_B. If so, a STAND-BY counter is incremented in step 907. If not, then step 909 detects if the consumed electrical current is less than THRESHOLD_C. If so, a LIGHT_USAGE counter is incremented. If not, then step 911. If not, then step 913 detects if the consumed electrical current is less than THRESHOLD_D. If so, a MODERATE_USAGE counter is incremented. If not, a HEAVY_USAGE counter is incremented.

The degree of usage is related to the mode of operation. For example the degree of usage is order (from least intensive to most intensive): INACTIVE, STAND-BY, LIGHT-USAGE, MODERATE_USAGE, and HEAVY_USAGE. The measured usage (MEASURED_USAGE) is determined by a usage time that is weighed in accordance with the mode of operation. For example, different usage factors may be associated with the different modes of operation: 0, W1, W2, W3, and W4 corresponding to the inactive mode, stand-by mode, light_usage mode, moderate_usage mode, and heavy_usage mode, respectively. Thus, the measured usage time (USAGE_TIME) may be determined by:
USAGE_TIME=T*(W1*STAND-BY+W2*LIGHT_USAGE+W3*MODERATE_USAGE+W4*HEAVY_USAGE)
where the corresponding counters are updated every T seconds.

Other embodiments of the invention may measure usage time differently. For example, the usage time may include usage only when an electrical product is operated in the heavy_usage mode. Also, the measured usage time may be time-stamped, e.g., by year and month.

While usage may be gauged by usage time, some embodiments of the invention may gauge the usage by the number of operating cycles (e.g., associated with a washing machine) or by the number of songs played (e.g., associated with an iPOD) corresponding to a number of data files accessed by an electronic product.

As previously discussed in the context of FIGS. 3, 4, and 5, the usage time may be processed as raw data (e.g., raw input data as shown in step 303 in FIG. 3) in processing a warranty claim. With an embodiment of the invention, a warranty may limit the usage time in addition to other sensory data (e.g., recorded impacts of an electronic product). For example, a warranty may be invalid if the product is commercially used (e.g., 7 days for nearly 24 hours each day). By providing a measure of the usage, one may check the warranty status of the product through a device interface in accordance with the system architecture as shown in FIG. 1.

Embodiments of the invention detect the actual usage of systems and subsystems and establishing corresponding warranty. For example, a DVD player would include an embedded device that monitors use (as well as environmental factors and misuse). A manufacturer may provide a usage-based warranty. One may bring a DVD player in for service to a retailer. The retailer would be able to check and see how much the device was used and determine if the warranty has expired or to determine a price of an extended warranty.

Embodiments of the invention provide usage information to a customer (i.e., perspective buyer of an electrical product). For example, a customer may be able to determine the actual usage of a floor model and accordingly adjust the price of the product. As another example, a customer may be able to gauge a fair market price of a second-hand product based on a product grade (corresponding to a determination by flow diagram 400 as shown in FIG. 4).

As can be appreciated by one skilled in the art, a computer system with an associated computer-readable medium containing instructions for controlling the computer system may be utilized to implement the exemplary embodiments that are disclosed herein. The computer system may include at least one computer such as a microprocessor, a cluster of microprocessors, a mainframe, and networked workstations.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method for processing a warranty claim of an electrical product, comprising:
(a) obtaining, by a processor, a usage information from an embedded device that is integrated with the electronic product, the usage information being indicative of a degree of usage of the electrical product;
(b) accessing, by the processor, a warranty threshold corresponding to the degree of usage for the electrical product;
(c) if the degree of usage exceeds the warranty threshold, rejecting the warranty claim; and
(d) if the degree of usage does not exceed the warranty threshold, accepting the warranty claim.

2. The method of claim 1, further comprising:
(e) determining whether the degree of usage occurred during a warranty time period; and
wherein (b) comprises:
(b)(i) obtaining a timestamp that is associated with the usage information; and
(b)(ii) determining whether the timestamp is within the warranty time period.

3. The method of claim 1, further comprising:
(e) in response to (d), submitting, by the processor, the warranty claim.

4. The method of claim 1, wherein the usage information corresponds to a usage time.

5. The method of claim 1, further comprising:
(a)(i) categorizing the usage time based on at least one mode of operation to form at least one usage category;
(a)(ii) weighing the at least one usage category to form at least one weighted usage category; and
(a)(iii) determining the degree of usage from the at least one weighted usage category.

6. The method of claim 1, wherein the usage information corresponds to a number of operation cycles.

7. The method of claim 1, wherein the usage information corresponds to a number of accessed data files.

8. The method of claim 1, wherein the usage information corresponds to an amount of electrical usage of the electrical product.

9. A method for processing a warranty claim of an electrical product, comprising:
(a) obtaining, by a processor, a data input from a sensor that is integrated with the electrical product;
(b) obtaining, by the processor, a usage information from an embedded device that is integrated with the electrical product, the usage information being indicative of a degree of usage of the electrical product;
(c) accessing, by the processor, threshold information corresponding to the degree of usage and the data input for the electrical product; and
(d) comparing the threshold information with the degree of usage and the data input to determine whether the warranty claim is valid.

10. A method for determining an extended warranty cost of an electrical product, comprising:
(a) obtaining, by a processor, a usage information from an embedded device that is integrated with the electrical product, the usage information being indicative of a degree of usage of the electrical product;
(b) accessing, by the processor, a first quality indicator corresponding to the degree of usage for the electrical product;
(c) determining a first quality parameter from the first indicator based on a first operating threshold;
(d) estimating a product grade from the first quality parameter; and
(e) estimating the extended warranty cost from the product grade.

11. The computerized method of claim 10, further comprising:
(f) obtaining, by the processor, a data input from a sensor;
(g) accessing, by the processor, a second quality indicator corresponding to the data input for the electrical product;
(h) determining a second quality parameter from the second quality indicator based on a second operating threshold;
(i) weighing the first quality parameter and the second quality parameter; and
(j) summing the weighted first and second quality parameters to estimate the extended warranty cost.

12. The computerized method of claim 10, wherein (e) comprises:
(e)(i) determining a quality estimate value of the electrical product;
(e)(ii) determining a historical warranty value of the electrical product; and
(e)(iii) determining the estimated warranty cost from the quality estimate value and the historical warranty value.

13. The method of claim 10, wherein the usage information corresponds to a usage time.

14. The method of claim 13, further comprising:
(a)(i) categorizing the usage time based on at least one mode of operation to form at least one usage category;
(a)(ii) weighing the at least one usage category to form at least one weighted usage category; and
(a)(iii) determining the degree of usage from the at least one weighted usage category.

15. The method of claim 10, wherein the usage information corresponds to an amount of electrical usage of the electrical product.

16. An apparatus that analyzes warranty information from an electrical product, comprising:
a communications module that receives a signal over a communications channel from the electrical product, the signal containing the warranty information and the warranty information includes a usage information from an embedded device that is integrated with the electrical product, the usage information being indicative of a degree of usage;
a rules engine that determines whether the degree of usage complies to a warranty agreement for the electrical product; and
a processing component computer that obtains the warranty information from the communications module and that determines, by querying the rules engine, whether the warranty information complies to the warranty agreement.

17. The apparatus of claim 16, further comprising:
a product history service component that stores the warranty information.

18. The apparatus of claim 17, wherein the product history service component comprises a product value estimator that determines an estimated value of the electrical product from the warranty information.

19. The apparatus of claim 17, wherein the product history service component comprises an extended warranty cost estimator that determines an extended warranty cost from the warranty information.

20. The apparatus of claim 17, wherein the product history service component comprises a product grade estimator that determines a product grade from the warranty information.

21. An apparatus that obtains warranty information for an electrical product, comprising:
an embedded device that is integrated with the electronic product and that obtains a usage information for the electronic product, the usage information being indicative of a degree of usage of the electrical product;
a device interface that receives a query request, the query request being indicative that a warranty validity for the electronic product is to be verified; and
a communications module that sends a transmitted signal over a communications channel from the electrical product in response to the query request, the transmitted signal containing the usage information, that receives a received signal, the received signal containing warranty status information, and that provides the warranty status information through the device interface.
